(19) United States
(12) Patent Application Publication
(10) Pub. No.: US 2025/0102031 A1
(43) Pub. Date: Mar. 27, 2025

(54) Radial Piston Machine with Multi-Disc Brake

(71) Applicant: Robert Bosch GmbH, Stuttgart (DE)

(72) Inventor: Evangelos Rompogiannakis, Glasgow (GB)

(21) Appl. No.: 18/897,209

(22) Filed: Sep. 26, 2024

(30) Foreign Application Priority Data
Sep. 27, 2023 (DE) 10 2023 209 471.1

(51) Int. Cl. F16D 65/18; F16D 55/00; F16D 121/06; F16D 125/06

(52) U.S. Cl. CPC F16D 65/183; F16D 2055/0033; F16D 2121/06; F16D 2125/06

(57) ABSTRACT

A radial piston machine includes a multi-disc brake, a brake disc assembly of which interacts with a first annular section on a drive shaft and a second annular section on a housing. The brake disc assembly is disposed within a brake chamber. The first annular section and the second annular section each delimit the brake chamber in sections. A disc section, a spring, a brake piston, and the brake disc assembly are disposed next to one another in a specified sequence along an axis of rotation in such a way that a force of the spring is transmitted to the brake disc assembly.

This application claims priority under 35 U.S.C. § 119 to patent application no. DE 10 2023 209 471.1, filed on Sep. 27, 2023 in Germany, the disclosure of which is incorporated herein by reference in its entirety.

The disclosure relates to a radial piston machine.

### BACKGROUND

A radial piston machine with a multi-disc brake is known from EP 2 841 763 B1. The corresponding design of the radial piston machine is characterized by the fact that it requires very little installation space in the direction of the axis of rotation. This is primarily achieved by the brake disc assembly of the multi-disc brake being disposed around the at least one pivot bearing of the drive shaft. For this purpose, the drive shaft comprises a first annular section, which is integrally connected to a shaft section via a disc section. One half of the brake discs is non-rotatably connected to the first annular section, wherein another half of the brake discs is non-rotatably connected to a second annular section, which is part of a housing of the radial piston machine. The multi-disc brake is preloaded with a disc spring in the closed state. The multi-disc brake can be switched to an open state by pressurizing a brake chamber that is limited by an annular brake piston.

### SUMMARY

One advantage of the disclosure is that the radial piston machine requires even less installation space in the direction of the axis of rotation. In addition, it is significantly more cost-effective because it comprises fewer components, wherein very expensive components in particular can be dispensed with. The expensive annular mechanical seal (Duo Cone Seal) of EP 2 841 763 B1, with which the gap between the first annular section and the housing is tightly sealed, should be mentioned here in particular. Furthermore, there is no need for a separate oil reservoir to lubricate the brake discs.

It is proposed that the brake disc assembly is disposed within the brake chamber, wherein the first and second annular sections each delimit the brake chamber in sections, wherein the disc section, the spring, the brake piston and the brake disc assembly are disposed next to one another in the specified sequence along the axis of rotation in such a way that a force of the spring can be transmitted to the brake disc assembly.

The radial piston machine is preferably operated with a pressurized fluid, which is most preferably a liquid and in particular hydraulic oil. The radial piston machine is preferably operated as a motor, wherein it can also be operated as a pump, wherein mixed forms are also conceivable.

It is conceivable that the radial piston machine comprises a valve device by means of which it is possible to switch between several effective displacement volumes by short-circuiting individual or all working chambers. It is conceivable that a freewheeling operation is realized in which all working chambers are short-circuited so that the rotor can rotate freely without a fluid flow between the first and second working connections. In all other positions of the valve device, rotation of the rotor is preferably accompanied by a flow of fluid between the first and second working connections. The spring is preferably designed as a disc spring. The shaft section, the disc section and the first annular section of the drive shaft are preferably connected to each other in one piece.

The brake piston is preferably movable relative to the drive shaft in the direction of the axis of rotation. The corresponding movement path is preferably designed so large that the multi-disc brake can be switched between the closed and open state. The fluid distributor and the at least one pivot bearing are preferably disposed on opposite sides of the rotor in the direction of the axis of rotation.

Preferably, at least one pivot bearing is disposed radially to the axis of rotation between the shaft section and the second annular section. Most preferably, a first and a second pivot bearing are provided, which are disposed radially to the axis of rotation between the shaft section and the second annular section.

Advantageous further embodiments and improvements of the disclosure are given in the dependent claims.

It may be provided that the brake piston bears sealingly against the first annular section with a radially outer peripheral surface, wherein it bears sealingly against the shaft section with a radially inner peripheral surface, so that the drive shaft and the brake piston delimit a spring chamber in which the spring is disposed. This means that there is no relative rotation between the brake piston and the drive shaft, so that the brake piston can be sealed without any problems, wherein the sealing concept of the brake piston known from EP 2 841 763 B1 can be adopted.

A first fluid channel can be provided, which extends from the spring chamber to an interior of the housing completely inside the drive shaft. Without the first fluid channel, which leads from the spring chamber to the interior of the housing, the spring chamber would be almost tightly sealed. Unavoidable leakage towards the spring chamber could result in the desired movement of the brake piston being impeded. This is reliably avoided by the first fluid channel. The housing preferably has a leakage connection which opens into the aforementioned interior, wherein an essentially unpressurized tank can be connected to the leakage connection so that the interior is also essentially unpressurized, wherein any leakage occurring in the interior can flow off to the tank.

A separate closure ring can be provided, which is disposed radially to the axis of rotation between the first and the second annular section, wherein the closure ring limits the brake chamber in sections, wherein the brake disc assembly is disposed in the direction of the axis of rotation between the brake piston and the closure ring, so that a force of the spring can be supported on the closure ring, wherein the closure ring is supported in the direction of the axis of rotation on the first annular section. If the preferred one-piece drive shaft is used, the closure ring is helpful to install the brake disc assembly, brake piston and spring into the drive shaft. In principle, other divisions of the assembly comprising the drive shaft and the closure ring are possible. However, the proposed division results in optimum rigidity and strength of the radial piston machine.

It may be provided that the closure ring is supported on the first annular section in the direction of the axis of rotation by means of a separate retaining ring, wherein the corresponding connection is designed in such a way that the closure ring is also connected to the first annular section non-rotatably with respect to the axis of rotation. The retaining ring requires little installation space, wherein it can still safely transmit the forces that occur during operation. The aforementioned non-rotatable connection is preferably achieved by means of a frictional connection. It goes without saying that the torque that can be transmitted non-rotatably is limited at the top. During operation, preferably only the frictional torques of the various sealing rings act on the closure ring so that the specified transmittable torque is not exceeded.

It may be provided that the closure ring is connected non-rotatably to the first annular section radially on the outside, wherein at least one dynamic sealing ring is disposed radially on the inside of the closure ring between the closure ring and the second annular section. A dynamic sealing ring is a sealing ring in which the relative movement occurring in the sealing contact causes only slight wear, which only insignificantly impairs the desired sealing effect for a long time. In any case, in the context of the disclosure, the dynamic first and fourth sealing rings are exposed to the high pressure in the brake chamber, which additionally increases the aforementioned wear. In EP 2 841 763 B1, this unfavorable combination has just been avoided.

It may be provided that the at least one dynamic sealing ring comprises a first and a second sealing ring, which are disposed next to each other in the direction of the axis of rotation, so that a leakage chamber is formed between the first and the second sealing ring, wherein the first sealing ring directly seals the brake chamber, wherein it is designed such that a leakage flow can occur in the sealing engagement when the brake chamber is under pressure, wherein the second sealing ring is designed to be fluid-tight, wherein the leakage chamber is connected to the interior of the housing via a second fluid channel. The second sealing ring is preferably designed as a radial shaft seal. Accordingly, it is not particularly pressure-resistant, wherein it is permanently tight despite the rotary movement between the housing and drive shaft. The first sealing ring is preferably designed as a compression sealing ring, the sealing effect of which is activated by the pressure difference between the brake chamber and the leakage chamber. A corresponding first sealing ring is known from the Technical Bulletin “Turcon Buffer Ring” (Edition No. EPH035_08; August 2021) from Trelleborg. The leakage flow mentioned causes only slight wear on the first sealing ring despite the high pressure. Nevertheless, no pressure can build up in the leakage chamber due to the second fluid channel, which means that the second sealing ring essentially does not have to withstand any pressure stress. The second fluid channel preferably runs completely within the second annular section. It preferably opens into the interior between a first and a second pivot bearing. It goes without saying that the amount of leakage flow mentioned depends on the pressure in the brake chamber. The first sealing ring is preferably designed so that a leakage flow is present at normal brake pressures.

It is possible that a third sealing ring is disposed between the closure ring and the housing in the direction of the axis of rotation. Preferably, the third sealing ring comprises an annular rubber sealing lip, which is protected from particles entering the radial piston machine from the outside by a sheet metal ring. The third sealing ring is primarily used to protect the second sealing ring from particles penetrating from the outside, so that the second sealing ring has the longest possible service life. With the preferred design of the third sealing ring, it can be disposed as proposed on the one hand, wherein on the other hand its function is permanent.

It may be provided that a fourth sealing ring is disposed between the shaft section and the second annular section, which closes the brake chamber in a fluid-tight manner in such a way that a leakage flow can occur in the sealing engagement when the brake chamber is under pressure. The fourth sealing ring preferably uses the same sealing principle as the first sealing ring, wherein it is preferably designed as a compression sealing ring, in particular as a “buffer ring”. As the fourth sealing ring is directly adjacent to the interior of the housing, no further measures are required to dissipate the leakage flow. The pressure in the brake chamber preferably acts directly on the fourth sealing ring.

It may be provided that an end face of the first annular section facing away from the disc section interacts with the housing in the manner of a labyrinth seal. The labyrinth seal is intended to ensure that as few particles as possible can reach the third sealing ring from the outside, thus providing the best possible protection for the second sealing ring.

It may be provided that a first fastening flange is disposed on the outside of the housing, by means of which the radial piston machine can be fastened to a higher-level assembly, wherein a brake connection is disposed on the first fastening flange, wherein the brake connection is fluidically connected to the brake chamber. The higher-level assembly is, for example, the chassis of a hydraulically driven vehicle, wherein the radial piston engine is operated as a radial piston machine that directly drives an assigned wheel or an assigned track of the vehicle. The first annular section of the drive shaft can be provided with a second fastening flange to which, for example, the aforementioned wheel is fastened. The brake connection is preferably disposed on an outer peripheral surface of the first fastening flange. The brake connection is preferably permanently fluidically connected to the brake chamber, most preferably via a third fluid channel that runs exclusively in the housing, in particular in the third housing section.

It is understood that the above-mentioned features and those to be explained below can be used not only in the combination indicated in each case, but also in other combinations or on their own, without going beyond the scope of the disclosure.

### BRIEF DESCRIPTION OF THE DRAWINGS

The disclosure is explained in more detail below with reference to the enclosed drawings. Shown are:

FIG. 1 a perspective view of a radial piston machine according to the disclosure;

FIG. 2 a longitudinal section of the radial piston machine according to FIG. 1; and

FIG. 3 an enlarged section of FIG. 2 in the area of the multi-disc brake.

### DETAILED DESCRIPTION

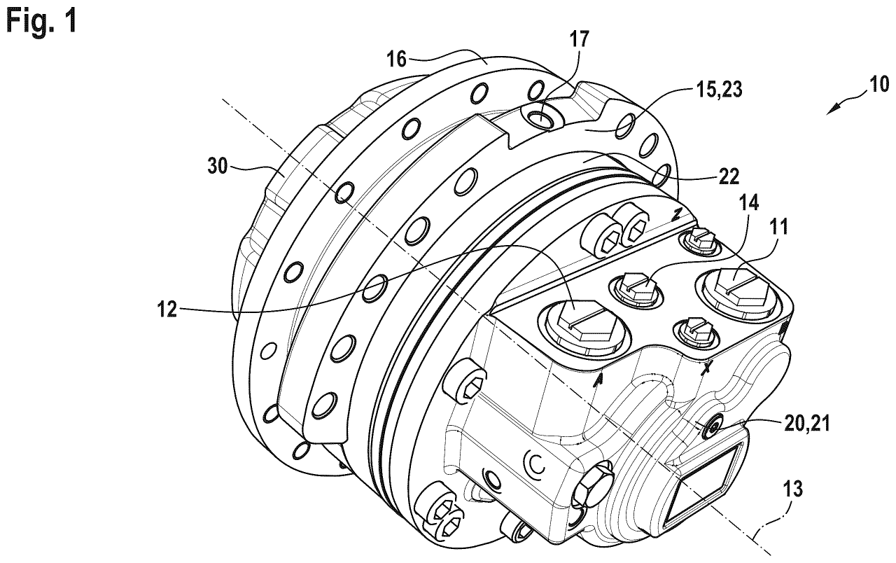

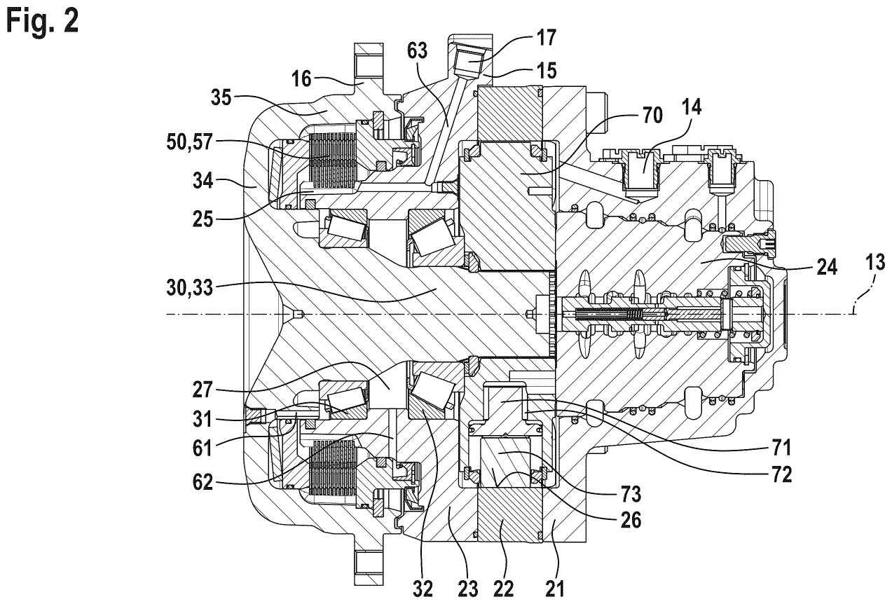

FIG. 1 shows a perspective view of a radial piston machine 10 according to the disclosure. The radial piston machine 10 comprises a housing 20, which in the present case is composed of a first, a second and a third housing section 21; 22; 23, which are disposed next to each other along the axis of rotation 13 and are firmly connected to each other. The first and second working connections 11; 12 are disposed on the outside of the first housing section 21, wherein the fluid distributor (no. 24 in FIG. 1) is disposed inside the first housing section 21. The inner peripheral surface of the second housing section 21 forms the control surface (no. 26 in FIG. 2), which moves the pistons (no. 71 in FIG. 2). The two pivot bearings (no. 31; 32 in FIG. 2), with which the drive shaft 30 is rotatably fastened in relation to the axis of rotation 13, are attached to the third housing section. A first fastening flange 15 is disposed on the housing 20, in particular on the third housing section 23, with which the radial piston machine 10 can be fastened to a higher-level assembly, for example the chassis of a hydraulically driven vehicle. A second fastening flange 16 is disposed on the drive shaft 30, with which the radial piston motor 10 can be fastened to a subordinate assembly, for example the wheel of said vehicle.

In the context of the disclosure, it has proved advantageous to arrange the brake connection 17, with which the present multi-disc brake is hydraulically released, on the first fastening flange 15, in particular on its outer peripheral surface.

FIG. 2 shows a longitudinal section of the radial piston machine 10 according to FIG. 1. The rotor 70 can be seen rotating together with the drive shaft 30 with respect to the axis of rotation 13. In the present case, the shaft section 33 of the drive shaft 30 is connected non-rotatably to the rotor 70 via splines with respect to the axis of rotation 13.

The drive shaft 30 is rotatably mounted on the housing 20 with a first and a second pivot bearing 31; 32 with respect to the axis of rotation 13, both of which are disposed on the same side of the rotor 70. The pivot bearings 31; 32 are designed in the present case as tapered roller bearings, wherein their inner ring is accommodated in each case on the shaft section 33 of the drive shaft 30, wherein the outer ring is accommodated in each case on the inside of the second annular section 25 of the third housing section 23.

On the side of the rotor 70 facing away from the pivot bearings 31; 32, the fluid distributor 24 is accommodated in the housing 20, in particular in the first housing section 21, so that it cannot rotate. The fluid distributor 24 is preferably designed such that the hydraulic forces acting inside it press the fluid distributor 24 against the rotor 70, wherein the rotor 70 in turn bears against the second pivot bearing 32 in order to support the corresponding force.

In the rotor 70, nine pistons 71 identical to one another are accommodated in the present case, each of which can move linearly radially with respect to the axis of rotation 13, wherein together with the rotor 70 they each delimit a working chamber 72 with a variable volume. Each piston 70 preferably comprises a rotatable roller 73, which is essentially circular-cylindrical in shape, wherein it is most preferably mounted hydrostatically on the piston 71. During operation, the roller 73 is in contact with the control surface 26 on the second housing section 22. The control surface 26 extends at a variable distance around the axis of rotation. The course of the control surface 26 is sinusoidal with six distance maxima and six distance minima. A piston 71 therefore performs six strokes during one full rotation of the rotor 70. It is understood that the number of pistons 71 and the number of strokes per rotor revolution can be selected as required.

Each working chamber 72 has a first control opening on the rotor 70, which opens out towards the fluid distributor 24, wherein the first control openings is disposed on a common pitch circle. In the present case, the fluid distributor 24 has a total of twelve second control openings, which are disposed on the same pitch circle so that they can be brought into overlap with the first control openings. There are two second control openings for each stroke that a piston 71 performs during a full rotation of the rotor 70. The second control ports are connected alternately to the first and second working connections 11; 12 along the periphery when the radial piston machine 10 is operated at its maximum displacement volume. Some or all of the second control openings can be short-circuited by means of a valve unit in order to reduce the effective displacement volume of the radial piston machine 10 compared to the maximum displacement volume or to reduce it completely to zero, wherein the rotor 70 rotates freely in the latter case.

At the end facing away from the fluid distributor 24, the solid shaft section 33 of the drive shaft 30 is connected in one piece to a first annular section 35 of the drive shaft 30 via a disc section 34. The first annular section 35 surrounds the shaft section 33 like a circular ring, wherein the brake disc assembly 50 of the multi-disc brake 57 is disposed within the first annular section 35. The second annular section 25, which is firmly connected to the housing 20, protrudes in sections into the first annular section 35, so that the aforementioned brake disc assembly 50 is disposed around the outside of the second annular section 25.

The brake disc assembly 50 comprises several first and several second brake discs 51; 52, which are disposed alternately next to one another along the axis of rotation 13. The first brake discs 51 are non-rotatably connected to the first annular section 35. For this purpose, the first annular section 35 has several grooves running parallel to the axis of rotation 13 on its inner peripheral surface, in each of which an extension of a first brake disc 51 engages positively. The second annular section 25 has comparable grooves on its outer peripheral surface, which run parallel to the axis of rotation 13, wherein projections of the second brake discs 52 engage positively in each case. The grooves mentioned are preferably evenly distributed around the axis of rotation 13.

A special feature of the disclosure is that the brake disc assembly 50 is disposed within the brake chamber 58. As a result, the first and second annular sections 35; 25 each delimit the brake chamber 58 in sections. The brake piston 54, which moves in the direction of the axis of rotation 13, is disposed between the brake disc assembly 50 and the disc section 34 and extends in a ring around the axis of rotation 13. This also limits the brake chamber 58. The spring 53, with which the multi-disc brake is preloaded into the closed state, is in turn disposed between the brake piston 54 and the disc section 34. The spring 53 is preferably designed as a single disc spring. It is conceivable that the spring comprises several helical springs that are evenly distributed around the axis of rotation 13.

The interior 27 of the housing 20 should also be noted. This interior 27 is defined as the space within the housing 20 that is permanently fluidically connected to the leakage connection 14 with low flow resistance. This interior 27 is partially or completely filled with pressurized fluid during operation of the radial piston machine 10, wherein this filling is primarily caused by unavoidable leaks at various points of the radial piston machine 10.

These leaks are preferably discharged to an essentially unpressurized tank via the leakage connection 14.

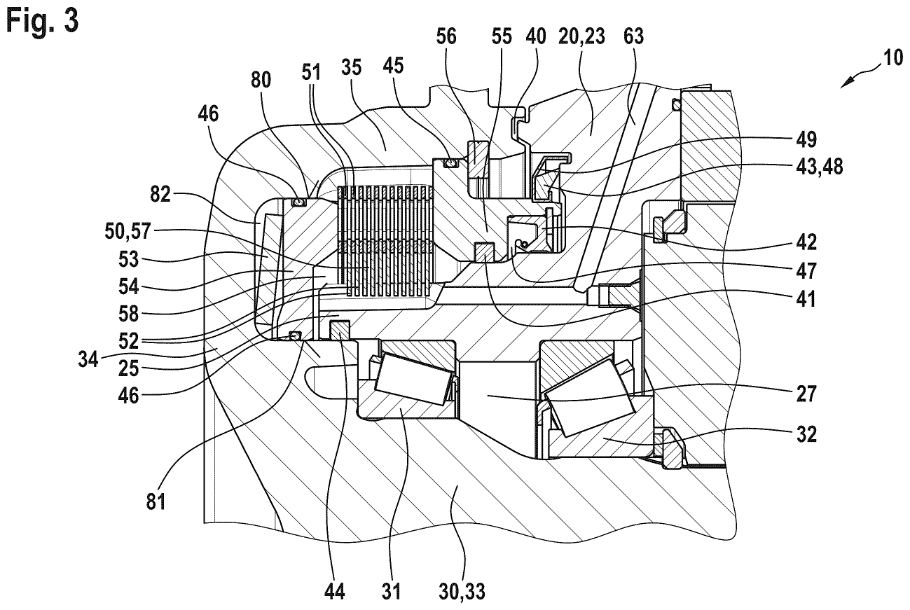

FIG. 3 shows an enlarged section of FIG. 2 in the area of the multi-disc brake 57. The design of the brake chamber 58 explained above means that it is bounded by surfaces which rotate relative to each other with respect to the axis of rotation (no. 13 in FIG. 2) during operation of the radial piston machine 10. The design of EP 2 841 763 B1 avoids precisely this situation. As a result, the design of the first and fourth sealing rings 41; 42 is critical for the function of the multi-disc brake 57, since on the one hand they must withstand the pressure in the brake chamber 58, wherein on the other hand they must resist the wear caused by the aforementioned rotary movement for a long time.

The first and fourth sealing rings 41; 42 are therefore designed such that they directly seal the brake chamber 58, wherein a leakage flow results or can result in the sealing engagement if the brake chamber is under pressure. It should be noted here that the brake pressure for the radial piston machine 10 in question is usually provided by a hydraulic pump, which can easily replace the leaks. It goes without saying that the aforementioned leakage flow is designed to be so small that the brake pressure required for release can be generated in the brake chamber. At the same time, however, it is preferably designed to be so large that the leakage flow causes a hydrostatic lubricating film in the sealing contact, which significantly minimizes the wear that occurs there.

In both sealing cases, the leakage flow is directed into the interior 27 of the housing 20 so that it can be directed away from the radial piston machine 20 via the leakage connection (no. 14 in FIG. 2). The fourth sealing ring 44 is therefore disposed between the shaft section 33 of the drive shaft 30 and the second annular section 25, as it is directly adjacent to the interior 27, so that no further measures are required to divert the leakage flow. The leakage flow also improves the lubrication of the first pivot bearing 31 disposed there. In the present case, the fourth sealing ring 44 is accommodated in a groove in the shaft section 33, wherein it seals against a circular cylindrical inner peripheral surface of the second annular section 25 with respect to the axis of rotation (no. 13 in FIG. 2).

Sealing in the area of the first sealing ring 41, on the other hand, is much more complex, as there is a risk that the desired leakage flow will reach the surroundings of the radial piston machine via the gap in the area of the labyrinth seal 40 between the drive shaft 30 and the housing 20. A completely tight seal is desired there. It should also be noted that it must be possible to fit the multi-disc brake.

It was initially decided to make the drive shaft 30 with the shaft section 33, the disc section 34 and the first annular section 35 in one piece so that the forces acting on the second flange (no. 16 in FIG. 1) can be transmitted to the first flange (no. 15 in FIG. 1) and vice versa with as little elastic deformation of the radial piston machine 10 as possible. The annular brake piston 54 lies exclusively against the one-piece drive shaft 30 on the inside 81 and outside 80, so that the sealing principle on the brake piston 54 known from EP 2 841 763 B1 can be adopted unchanged. For example, sixth sealing rings 46 in the form of O-rings are accommodated in the corresponding annular grooves, which are preferably protected against wear in the area of the sealing contact by a harder sliding ring.

So that the spring 53, the brake piston 54 and the brake disc assembly 50 in FIG. 3 can be mounted from the right, a separate closure ring 55 is provided, which is fastened to the inside of the first annular section 35 by means of a retaining ring 56. The retaining ring 56 initially transmits the forces acting in the direction of the axis of rotation (no. 13 in FIG. 2), which are caused by the spring 53 and/or by the pressure in the brake chamber 58. It also causes the closure ring 55 to rotate with the drive shaft 30 during operation of the radial piston motor 10. A fifth sealing ring 45 is accommodated in a groove on the outside of the closure ring 55, which is designed as a simple O-ring, for example, because only an unproblematic static seal is required there.

The first sealing ring 41 already mentioned is accommodated in a groove on the inner peripheral surface of the closure ring 55, wherein it seals against a circular cylindrical surface on the second annular section 35 with respect to the axis of rotation (no. 13 in FIG. 2). The leakage flow there is directed into the interior 27 of the housing 20 via the second fluid channel (no. 62 in FIG. 2). The second fluid channel (item 62 in FIG. 2) is designed as a straight bore, which passes through the second annular section 25 radially to the axis of rotation (item 13 in FIG. 2), wherein it opens externally into a leakage chamber 47, which is bounded by the first and second sealing rings 41; 42. The low pressure of the interior 27 therefore prevails in the leakage chamber 47. The second sealing ring 42 is therefore only subjected to a low pressure, wherein it is designed as a radial shaft sealing ring, for example, which seals against a circular cylindrical surface on the second annular section 25 with respect to the axis of rotation (no. 13 in FIG. 2). A sealing ring of this type is completely tight and permanently withstands the rotary movement in the sealing engagement. However, it is very sensitive to particles penetrating from outside.

This radial piston machine is used in construction machinery, for example, so it is to be expected that sand and/or mud will act on the radial piston machine 10 from the outside. In order to make it more difficult for the corresponding particles to penetrate from the outside, the labyrinth seal 40 was initially provided between the free end face of the first annular section 35 and the housing 20. The corresponding sealing gap is preferably designed in such a way that particles can pass more easily from inside the radial piston machine 10 to outside the radial piston machine 10 than vice versa. In addition, the third sealing ring 43 is provided, which is accommodated on one end face of the closure ring 55, wherein its rubber sealing lip 48 seals against a sealing surface on the housing 20 perpendicular to the axis of rotation (no. 13 in FIG. 2). This rubber sealing lip 48 is protected from the aforementioned particles by a sheet metal ring 49. This sheet metal ring 49 preferably carries the rubber sealing lip 48, wherein its free end engages in a groove in the housing 20, resulting in a further sealing labyrinth.

The spring 53 is designed as a disc spring, which is accommodated in the spring chamber 82 between the drive shaft 30 and the brake piston 54. Without the first fluid channel (no. 61 in FIG. 2), which leads from the spring chamber 82 to the interior 27 of the housing, the spring chamber 82 would be almost tightly sealed. Unavoidable leakage towards the spring chamber 82 could result in the desired movement of the brake piston 54 being impeded. This is reliably prevented by the first fluid channel (no. 61 in FIG. 2).

It should also be noted that the third fluid channel 63 (see also FIG. 2) permanently connects the brake chamber 58 with the brake connection (no. 17 in FIG. 2). The third fluid channel 63 is composed of two straight bores, which run completely through the third housing section 23.

### REFERENCE NUMERALS

10 Radial piston machine
11 First working connection
12 Second working connection
13 Axis of rotation
14 Leakage connection
15 First fastening flange
16 Second fastening flange
17 Brake connection
20 Housing
21 First housing section
22 Second housing section
23 Third housing section
24 Fluid distributor
25 Second annular section
26 Control surface
27 Interior of the housing
30 Drive shaft
31 First pivot bearing
32 Second pivot bearing
33 Shaft section
34 Disc section
35 First annular section
40 Labyrinth seal
41 First sealing ring
42 Second sealing ring
43 Third sealing ring
44 Fourth sealing ring
45 Fifth sealing ring
46 Sixth sealing ring
47 Leakage chamber
48 Rubber sealing lip of the third sealing ring
49 Sheet metal ring of the third sealing ring
50 Brake disc assembly
51 First brake disc
52 Second brake disc
53 Spring
54 Brake piston
55 Closure ring
56 Retaining ring
57 Multi disc brake
58 Brake chamber
61 First fluid channel
62 Second fluid channel
63 Third fluid channel
70 Rotor
71 Piston
72 Working chamber
73 Roller
80 Radial outer peripheral surface of the brake piston
81 Radial inner peripheral surface of the brake piston
82 Spring chamber

What is claimed is:

1. A radial piston machine, comprising:
a housing including a first working connection and a second working connection;
a drive shaft including at least one pivot bearing rotatably mounted in the housing with respect to an axis of rotation;
a rotor configured to accommodate a plurality of pistons, the drive shaft connected to the rotor non-rotatably with respect to the axis of rotation, the plurality of pistons radially movable with respect to the axis of rotation so that the rotor and the plurality of pistons each delimit an associated working chamber; and
a control surface surrounding the axis of rotation in a ring-like manner, the control surface disposed on an inside of the housing,
wherein a distance between the control surface and the axis of rotation is variable along a periphery of the control surface so that a volume of a corresponding working chamber of the delimited working chambers changes periodically when a respective piston of the plurality of pistons contacts the control surface, while the rotor rotates with respect to the axis of rotation,
wherein the housing comprises a fluid distributor configured to cooperate with the rotor in such a way that the delimited working chambers are fluidically connected alternately to the first working connection and the second working connections when the rotor rotates with respect to the axis of rotation,
wherein the drive shaft comprises a shaft section, a disc section, and a first annular section fixedly connected to one another,
wherein the housing comprises a second annular section disposed at least partially within the first annular section,
wherein a brake disc assembly with a plurality of separate brake discs is disposed radially to the axis of rotation between the first annular section and the second annular section,
wherein the brake discs of the plurality of brake discs are alternately non-rotatably connected to either the first annular section or the second annular section, so that a multi-disc brake is produced,
wherein the brake disc assembly is pretensioned by a spring into a closed state of the multi-disc brake,
wherein a ring-like brake piston is configured to delimit a brake chamber in sections,
wherein the brake piston interacts with the brake disc assembly and the spring in such a way that the multi-disc brake is brought into an open state by pressurizing the brake chamber,
wherein the brake disc assembly is disposed within the brake chamber,
wherein the first annular section and the second annular section each delimit the brake chamber in sections, and
wherein the disc section, the spring, the brake piston, and the brake disc assembly are disposed next to one another in a specified sequence along the axis of rotation in such a way that a force of the spring is transmitted to the brake disc assembly.

2. The radial piston machine according to claim 1, wherein the brake piston bears with a radially outer peripheral surface sealingly against the first annular section and the brake piston bears with a radially inner peripheral surface sealingly against the shaft section, so that the drive shaft and the brake piston delimit a spring chamber in which the spring is disposed.

3. The radial piston machine according to claim 2, wherein a first fluid channel extends from the spring chamber to an interior of the housing completely within the drive shaft.

4. The radial piston machine according to claim 1, wherein:
a separate closure ring is disposed radially to the axis of rotation between the first annular section and the second annular section,
the closure ring delimits the brake chamber in sections,
the brake disc assembly is disposed in a direction of the axis of rotation between the brake piston and the closure ring, so that a force of the spring is supported on the closure ring, and
the closure ring is supported on the first annular section in the direction of the axis of rotation.

5. The radial piston machine according to claim 4, wherein:
the closure ring is supported on the first annular section in the direction of the axis of rotation by a separate retaining ring, and
the corresponding connection is configured such that the closure ring is also connected to the first annular section non-rotatably with respect to the axis of rotation.

6. The radial piston machine according to claim 4, wherein:
the closure ring is non-rotatably connected to the first annular section radially on the outside, and
at least one dynamic sealing ring is disposed radially on the inside of the closure ring between the closure ring and the second annular section.

7. The radial piston machine according to claim 6, wherein:
the at least one dynamic sealing ring comprises a first sealing ring and a second sealing ring disposed next to each other in the direction of the axis of rotation, so that a leakage chamber is formed between the first sealing ring and the second sealing ring,
the first sealing ring directly seals the brake chamber,
a leakage flow occurs in the sealing engagement when the brake chamber is under pressure,
the second sealing ring is fluid-tight, and
the leakage chamber is connected to the interior of the housing via a second fluid channel.

8. The radial piston machine according to claim 7, wherein a third sealing ring is disposed between the closure ring and the housing in the direction of the axis of rotation.

9. The radial piston machine according to claim 8, wherein the third sealing ring comprises an annular rubber sealing lip protected by a sheet metal ring from particles penetrating into the radial piston machine from the outside.

10. The radial piston machine according to claim 8, wherein:
a fourth sealing ring is disposed between the shaft section and the second annular section, and
the fourth sealing ring closes the brake chamber in a fluid-tight manner such that a leakage flow occurs in the sealing engagement when the brake chamber is under pressure.

11. The radial piston machine according to claim 1, wherein an end face of the first annular section facing away from the disc section cooperates with the housing in a manner of a labyrinth seal.

12. The radial piston machine according to claim 1, wherein:
a first fastening flange is disposed on the outside of the housing, such that the radial piston machine is fastened to a higher-level assembly,
a brake connection is disposed on the first fastening flange, and
the brake connection is fluidically connected to the brake chamber.
